(19) United States
(12) Patent Application Publication
(10) Pub. No.: US 2026/0235048 A1
(43) Pub. Date: Aug. 13, 2026

(54) TURBINE

(71) Applicant: Cummins Ltd, London (GB)

(72) Inventors: Craig S. T. Hasler, Huddersfield (GB); Robert Dewhirst, Huddersfield (GB)

(21) Appl. No.: 19/156,329

(22) PCT Filed: Feb. 13, 2024
(86) PCT No.: PCT/GB2024/050385

§ 371 Date: Aug. 13, 2025

(30) Foreign Application Priority Data
Feb. 13, 2023 (GB) 2302033.2

(51) Int. Cl. F01D 25/24; F01D 9/04

(52) U.S. Cl. CPC F01D 25/24; F01D 9/04; F05D 2240/128; F05D 2240/14

(57) ABSTRACT

There is provided a turbine housing comprising a housing dividing wall circumferentially extending around a central axis of the turbine housing. The housing dividing wall axially separates a first inlet volute and a second inlet volute. The housing dividing wall comprises a circumferentially extending tip configured to receive a nozzle ring. The tip is shaped to impart a tortuous geometry upon a leakage passage defined between the first inlet volute and the second inlet volute.

### CROSS-REFERENCE TO RELATED APPLICATION

This application is a US national stage of and claims the priority benefit of International Patent Application No. PCT/GB2024/050385, Feb. 13, 2024, which claims priority to UK Patent Application No. 2302033.2, filed Feb. 13, 2023, the entire contents and disclosures of which are incorporated herein by reference.

### TECHNICAL FIELD

The present invention relates to a turbine housing and assembly for a twin-entry turbine, and in particular to such a turbine housing and assembly in which leakage between corresponding inlet volutes is reduced.

### BACKGROUND

Turbochargers are well known devices for supplying air to the intake of an internal combustion engine at pressures above atmospheric pressure (boost pressures). A conventional turbocharger comprises an exhaust gas driven turbine wheel mounted on a rotatable shaft within a turbine housing. Rotation of the turbine wheel rotates a compressor wheel mounted on the other end of the shaft within a compressor housing. The compressor wheel delivers compressed air to the intake manifold of the engine, thereby increasing engine power. The turbocharger shaft is conventionally supported by journal and thrust bearings, including appropriate lubricating systems, located within a central bearing housing connected between the turbine and compressor wheel housings.

In known turbochargers, the turbine stage comprises a turbine chamber within which the turbine wheel is mounted; a circumferentially extending inlet passageway defined between opposing walls arranged around the turbine chamber; an inlet volute arranged around the inlet passageway; and an outlet passageway extending from the turbine chamber. The passageways and chambers communicate such that pressurised exhaust gas admitted to the inlet volute flows through the inlet passageway to the outlet passageway via the turbine and rotates the turbine wheel. It is also known to improve turbine performance by providing vanes, referred to as nozzle vanes, in the inlet passageway so as to deflect gas flowing through the inlet passageway towards the direction of rotation of the turbine wheel.

Turbines may be of a fixed or variable geometry type. Variable geometry type turbines comprise mechanisms which permit the geometry of the inlet passageway to be varied during use. Fixed geometry type turbines do not comprise such mechanisms, and therefore the geometry of the inlet passages of a fixed geometry turbine cannot be adjusted during use.

Turbines may be of a single-entry or multiple-entry type. Single-entry turbines comprise a single inlet volute that typically receives all of the exhaust gas from an internal combustion engine. Multiple-entry turbines comprise more than one volute which typically receive separate streams of exhaust gas from different cylinder banks of an internal combustion engine. One form of multiple-entry turbine is a “twin-entry” turbine in which two volutes extend circumferentially with one another around the turbine axis in angular alignment with one another. In such “twin-entry” turbines, a dividing wall is used to separate the volutes from one another.

In multiple-entry turbines, the exhaust gas streams in the different inlet volutes will exhibit transient pressure pulses caused by the separate cylinder banks. Often this means that when a first volute exhibits high pressure an adjacent second volute exhibits low pressure. If the pressure difference between the two volutes is high enough, this will cause exhaust gas from the first (higher pressure) volute to spill over the dividing wall and into the second (lower pressure) volute. The presence of the high pressure gas in the second volute forms a fluid blockage which may impede exhaust gas flow through the second volute during the next exhaust gas cycle and thereby increase the pumping work required by the engine and resulting in engine energy losses. During the next exhaust gas cycle, high pressure gas in the second volute may spill over the dividing wall into the first volute to form a fluid blockage in the first volute. Such fluid interaction between the different volutes is known as “cross-talk”.

It is beneficial to keep inlet flow streams separated from one another until close as possible to the turbine wheel. By keeping the two flows separate until just before the turbine wheel energy losses are minimised. Therefore, in fixed geometry turbines comprising nozzle vanes, the dividing wall often extends through the nozzle vanes, for example in a plane generally orthogonal to the turbine axis. This ensures that the inlet flows remain separated until downstream of the trailing edges of the nozzle vanes, which are positioned in close proximity to the inducer of the turbine wheel.

Due to the complex geometry of the dividing wall and the nozzle ring, it is generally not possible to manufacture nozzle vanes integrally with the turbine housing. Accordingly, it is common for such turbines to comprise a nozzle ring and a turbine housing that are separate to one another. In such constructions, the nozzle ring defines the nozzle vanes and the portion of the dividing wall that passes through the nozzle vanes, whilst the turbine defines the inlet volutes and the portion of the dividing wall positioned between the inlet volutes. Because the nozzle ring and the turbine housing are separate to one another, an interface is defined between the portion of the dividing wall defined by the nozzle ring and the portion of the dividing wall defined by the turbine housing.

It is not possible to bring the nozzle ring into contact with the dividing wall of the turbine housing at the interface. Often, the turbine housing and the nozzle ring must be manufactured from different materials. During use, the nozzle ring and turbine housing will expand at different rates when heated by hot exhaust gas. Where no clearance is present, this causes the nozzle ring to exert a high stress on the dividing wall, which can cause material failure of the turbine housing. Accordingly, the nozzle ring and the dividing wall are sized such that a narrow clearance, or leakage passage, is present at the interface that allows some exhaust gas to pass therethrough. However, the presence of the clearance enables cross-talk to occur before the nozzle ring, and thus reduces the efficiency of the turbine.

It is an object of the present invention to mitigate or prevent leakage across a nozzle ring of a turbine. It is a further object of the invention to obviate or mitigate one or more disadvantages of the prior art whether described herein or elsewhere.

According to a first aspect of the invention there is provided a turbine housing comprising:
a housing dividing wall circumferentially extending around a central axis of the turbine housing, the housing dividing wall axially separating a first inlet volute and a second inlet volute;
wherein the housing dividing wall comprises a circumferentially extending tip configured to receive a nozzle ring, the tip being shaped to impart a tortuous geometry upon a leakage passage defined between the first inlet volute and the second inlet volute.

During use, when a pressure pulse is present in one of the inlet volutes, the fluid in that volute has a propensity to pass through the leakage passage and into the other volute. When the leakage passage is not tortuous, the path defined by the leakage passage is short, straight and direct. However, because the tip of the housing dividing wall is shaped to impart a tortuous shape on the leakage passage, the path defined by the leakage passage of the present invention is longer and more complex. This provides two effects. First, increasing the length of the leakage passage increases the surface area of the leakage passage in contact with the fluid passing therethrough. As a result, the fluid is exposed to increased frictional shearing forces applied by the surfaces of the leakage passage on the fluid, resulting in energy loss within the fluid. Secondly, increasing the complexity of the leakage passage causes the fluid passing therethrough to undergo one or more significant changes of direction. When the fluid changes direction, internal friction (i.e. viscous friction) between the particles within the fluid results in further energy losses. Accordingly, as compared to a straight leakage passage, a leakage passage having a tortuous geometry will result in greater energy loss within the fluid passing therethrough. The lower-energy fluid effectively “throttles” the leakage passage, restricting the flow therethrough and thereby reducing the overall amount of leakage from one volute to the other. Accordingly, the problems associated with cross-talk discussed above are mitigated.

The term “tortuous” encompasses substantially any geometry that causes the fluid passing through the leakage passage to undergo one or more changes in flow direction, and in particular significant changes in flow direction. This may include, for example, geometry that is configured to impart upon the leakage passage one or more bends, twists, turns, dog-legs, boustrophedonic paths, zig-zags or the like.

The term “leakage passage” encompasses a passage defined between the first inlet volute and the second inlet volute via which fluid may transfer between the volutes. In particular, such a leakage passage may be free of, and preferably substantially free of, mechanical sealing elements. Such mechanical sealing elements may include, for example: o-rings, sealing rings, compression joints, interference fits or any other mechanical structure configured to block or otherwise prevent flow through the leakage passage. Accordingly, in such embodiments, the sole means of leakage mitigation and/or prevention along the leakage passage between the first and second volutes is provided by frictional forces imparted on the fluid in the leakage passage due to the tortuous geometry of the leakage passage itself.

The tip may comprise a formation configured to impart a tortuous geometry upon the leakage passage. The term “formation” encompasses substantially any mechanical structure that is capable of deflecting or guiding a fluid such as exhaust gas. Such formations may comprise, inter alia, edges, protrusions, recesses, labyrinth seals, steps, or the like. The term “leakage passage” encompasses a spatial region at least partially defined between the tip of the housing dividing wall and the nozzle ring, which permits fluid communication between the first inlet volute and the second inlet volute.

The formation may comprise a stepped portion circumferentially extending around the central axis, the stepped portion defining at least part of the leakage passage. The term “stepped portion” encompasses sharp discontinuity in the tip or an abrupt change in radius between two surfaces of the tip. The stepped portion may be embodied, for example, by an annular surface extending between two cylindrical surfaces of the tip. Such a step may form part of the leakage passage, and therefore define a tortuous geometry as described above.

The stepped portion may define an inner edge, and the inner edge may be arcuate. The term “inner edge” encompasses an edge defined between two surfaces that form part of a concave structure. For example, an inner edge may be an edge defined by the inside of an elbow defining part of the stepped portion. The two surfaces defining the inner the edge may be oriented at approximately 90° relative to one another. The term “arcuate” encompasses a rounded geometry configured to provide a smooth transition between the two surfaces defining the inner edge. Such an arcuate edge helps to deflect incident flow along the tortuous geometry of the leakage passage, and therefore reduces the internal energy of the leaked fluid, enhancing the “throttling” effect. Additionally, the arcuate edge may reduce internal stresses within the material of the housing dividing wall. That is to say, the arcuate edge reduces the prevalence of stress concentrations within the tip of the housing dividing wall.

The stepped portion may define an outer edge, and the outer edge may be sharp. The term “outer edge” encompasses an edge defined between two surfaces that form part of a convex structure. For example, an outer edge may be an edge defined by the outside of an elbow defining part of the stepped portion. The two surfaces defining the outer edge may be oriented at approximately 90° relative to one another. The term “sharp” encompasses a substantially discontinuous change in angle between the two surfaces defining the outer edge. Because the outer edge is sharp, the boundary layer of the fluid flowing over the outer edge may separate from the stepped portion of the tip. Such flow separation can be used to effectively “narrow” the available flow area of the leakage passage, thus enhancing the “throttling” effect. In addition, the sharp edge may allow, or even encourage, the fluid passing thereover to continue to flow in a direction parallel to the central axis, such that said fluid collides with another object, for example a nozzle dividing wall of a nozzle ring.

The formation may be a first formation; and the tip further comprises a second formation defining at least part of the leakage passage, the second formation being configured to impart a tortuous geometry upon the leakage passage in combination with the first formation. Because the second formation imparts a tortuous geometry upon the leakage passage in combination with the first formation, the second formation therefore also contributes to the “throttling” effect of the leakage passage. Put another way, the second formation defines increases the degree of tortuousness of the tortuous path between the first and second inlet volutes, and thereby acts to further restrict flow between the two.

The second formation may be a second stepped portion circumferentially extending around the central axis, and the stepped portion may define at least part of the leakage passage. The second stepped portion may have a substantially corresponding structure to the first stepped portion described above.

The second stepped portion may define an inner edge, and the inner edge may be arcuate. The inner edge of the second stepped portion may have a substantially corresponding structure to the inner edge first stepped portion described above. In particular, the two surfaces defining the inner edge may be oriented at approximately 90° relative to one another.

The second stepped portion may define an outer edge, and the outer edge may be sharp. The outer edge of the second stepped portion may have a substantially corresponding structure to the outer edge first stepped portion described above. In particular, the two surfaces defining the outer edge may be oriented at approximately 90° relative to one another.

The second formation may be positioned opposite to the first formation about a plane normal to the central axis so as to define a recess therebetween. The term “recess” encompasses a groove or channel circumferentially extending about the central axis. Such a geometry is simple to manufacture and provides formations suitable for defining a requisitely tortuous path to reduce leakage between the inlet volutes.

The tip of the dividing wall may comprise a tab extending in a radial direction towards the central axis. The tip of the dividing wall may comprise a plurality of tabs, which may be equispaced about the central axis. The tab or tabs may be configured for receipt by a correspondingly shaped socket of a nozzle ring dividing wall (described below).

According to a second aspect of the invention there is provided a turbine housing assembly comprising:
the turbine housing of the first aspect of the invention; and
a nozzle ring comprising a nozzle ring dividing wall and at least one nozzle vane extending from the nozzle ring dividing wall;
wherein the nozzle ring dividing wall is aligned with the tip of the housing dividing wall such that the nozzle ring dividing wall and the tip of the housing dividing wall define the leakage passage therebetween.

The term “nozzle ring dividing wall” encompasses a generally annular flange-like structure extending in a generally radial direction relative to the central axis.

The formation may define an outer radius Rₒ and an inner radius Rᵢ. The nozzle ring dividing wall may define a nozzle ring radius Rₙ. The outer radius Rₒ may be larger than the nozzle ring radius Rₙ. The outer radius Rₒ of the formation may be around 0.5% to around 1.5%, and preferably around 0.9% or around 1%, larger than the nozzle ring radius Rₙ.

The inner radius Rᵢ may be equal to or greater than the nozzle ring radius Rₙ. Because the inner radius Rᵢ is equal to or greater than the nozzle radius Rₙ, this ensures that during assembly the nozzle dividing wall can be received within and pass through an aperture defined by the inner radius Rᵢ of the turbine housing dividing wall. However, even though no overlap between the formation and the nozzle ring dividing wall is created, the formation is still able to create a tortuous path that acts to reduce leakage through the leakage passage. The inner radius Rᵢ may be around 0.1% to around 0.5%, and preferably around 0.2% or 0.3%, larger than the nozzle ring radius Rₙ.

The turbine may be a turbine comprising a first formation and a second formation as described above. The inner radius Rᵢ may be an inner radius of the first formation and may define a first inner radius R_{1,i}. The second formation may define a second inner radius R_{2,i} The outer radius Rₒ may be a common outer radius of the first and second formations. The first inner radius R_{1,i} and the second inner radius R_{2,i} may be equal to or larger than the nozzle ring radius Rₙ. The first inner radius R_{1,i} and the second inner radius R_{2,i} may be around 0.1% to around 0.5%, and preferably around 0.2% or 0.18%, larger than the nozzle ring radius Rₙ.

The inner radius Rᵢ may be smaller than the nozzle ring radius Rₙ. Because the inner radius Rᵢ is smaller than the nozzle ring radius Rₙ, this creates a radial overlap between the housing dividing wall and the nozzle ring dividing wall. Such an overlap further increases the tortuousness of the leakage passage and thereby improves the sealing effect.

The inner radius Rᵢ of the formation may be around 0.3% to around 1.5%, and preferably around 0.4%, around 0.7% or around 1.1%, smaller than the nozzle ring radius Rₙ.

The turbine may be a turbine comprising a first formation and a second formation as described above. The first formation may define a first inner radius R_{1,i}. The inner radius Rᵢ may define an inner radius of the second formation and define a second inner radius R_{2,i}. The outer radius Rₒ may be a common outer radius of the first and second formations. The first inner radius R_{1,i} may be equal to or greater than the nozzle ring radius Rₙ. The second inner radius R_{2,i} may be less than the nozzle ring radius Rₙ. Because the first inner radius R_{1,i} is equal to or greater than the nozzle ring radius Rₙ, and the second inner radius R_{2,i} is less than the nozzle ring radius Rₙ, this ensures that during assembly the nozzle ring dividing wall can be received within and pass through an aperture defined by the first inner radius R_{1,i} of the housing dividing wall and that a radial overlap is created between the housing dividing wall and the nozzle ring dividing wall by the second inner radius R_{2,i}.

The first inner radius R_{1,j} may be around 0.1% to around 0.5%, and preferably around 0.2% or 0.18%, larger than the nozzle ring radius Rₙ. The second inner radius R_{2,i} may be around 0.3% to around 1.5%, and preferably around 0.4%, around 0.7% or around 1.1%, smaller than the nozzle ring radius Rₙ.

The turbine may be a turbine comprising a first formation and a second formation as described above. The inner radius Rᵢ may be an inner radius of the first formation and defines a first inner radius R_{1,i}. The second formation may define a second inner radius R_{2,i}. The outer radius Rₒ may be a common outer radius of the first and second formations. The first inner radius R_{1,i} may be equal to or less than the nozzle ring radius Rₙ. The second inner radius R_{2,i} may be equal to or less than the nozzle ring radius Rₙ. Because the first inner radius R_{1,i} is equal to or less than the nozzle ring radius Rₙ; and the second inner radius R_{2,i} is equal to or less than the nozzle ring radius Rₙ, this ensures that a radial overlap is created between both formations of the housing dividing wall and the nozzle ring dividing wall. Such an embodiment is manufacturable, for example, by additive manufacturing or by thermally shrinking the nozzle ring and/or thermally expanding the turbine housing to enable the nozzle ring to pass through the first and/or second formations.

The first inner radius R_{1,i} and the second inner radius R_{2,i} may be around 0.3% to around 1.5%, and preferably around 0.4%, around 0.7% or around 1.1%, smaller than the nozzle ring radius Rₙ.

The turbine may be a turbine comprising a first formation and a second formation as described above. The nozzle ring dividing wall may be axially aligned with a midpoint between the first formation and the second formation.

According to a third aspect of the invention, there is a provided a nozzle ring for a twin-entry turbine comprising a first inlet volute and a second inlet volute separated by a housing dividing wall, the nozzle ring comprising:
a nozzle ring dividing wall circumferentially extending around a central axis of the nozzle ring;
at least one nozzle vane extending from the nozzle ring dividing wall;
wherein the nozzle ring dividing wall comprises a circumferentially extending tip configured to be received by the housing dividing wall, the tip being shaped to impart a tortuous geometry upon a leakage passage defined between the first inlet volute and the second inlet volute.

The advantages of such an arrangement, as well as the definitions of “tortuous” and “leakage passage” may be the same as set out above in relation to the first aspect of the invention.

The tip may comprise a formation configured to impart a tortuous geometry upon the leakage passage. The formation may comprise a stepped portion circumferentially extending around the central axis, the stepped portion defining at least part of the leakage passage. The stepped portion may define an inner edge, and the inner edge may be arcuate. The stepped portion may define an outer edge, and the outer edge may be sharp.

The formation may be a first formation; and the tip may further comprise a second formation defining at least part of the leakage passage, the second formation being configured to impart a tortuous geometry upon the leakage passage in combination with the first formation. The second formation may be a second stepped portion circumferentially extending around the central axis, the stepped portion defining at least part of the leakage passage. The second stepped portion may define an inner edge, and the inner edge may be arcuate. The second stepped portion may define an outer edge, and the outer edge may be sharp.

The second formation may be positioned opposite to the first formation about a plane normal to the central axis so as to define a recess therebetween.

The nozzle ring dividing wall may comprise a socket configured to receive a corresponding tab of the housing dividing wall. The nozzle ring dividing wall may comprise a plurality of sockets, which may be equispaced around the central axis.

According to a fourth aspect of the invention, there is provide a turbine housing assembly comprising:
the nozzle ring of the third aspect of the invention; and
a turbine housing comprising a housing dividing wall circumferentially extending around a central axis of the turbine housing, the housing dividing wall axially separating a turbine inlet into a first inlet volute and a second inlet volute, wherein the housing dividing wall comprises a circumferentially extending tip;
wherein the tip of the nozzle ring dividing wall is aligned with the tip of the housing dividing wall such that the tip of the nozzle ring dividing wall and the tip of the housing dividing wall define the leakage passage therebetween.

According to a fifth aspect of the invention, there is provided a turbine housing assembly comprising:
a turbine housing according to the first aspect of the invention; and
a nozzle ring according to the third aspect of the invention;
wherein the tip of the nozzle ring dividing wall is aligned with the tip of the housing dividing wall such that the tip of the nozzle ring dividing wall and the tip of the housing dividing wall define the leakage passage therebetween.

### BRIEF DESCRIPTION OF THE DRAWINGS

A detailed description of a number of embodiments of the present invention is set forth below with reference to the accompanying drawings, in which:

FIG. 1 is a cross-sectional schematic view of a turbine comprising a turbine housing assembly having a turbine housing according to an embodiment of the present invention;

FIG. 2 is a cross-sectional schematic view of a portion of the turbine of FIG. 1;

FIG. 3 is a cross-sectional schematic view of a further portion of the turbine of FIG. 1;

FIG. 4 is a cross-sectional schematic view of a portion of an alternative embodiment of a turbine housing assembly comprising a turbine housing according to the present invention;

FIG. 5 is a cross-sectional schematic view of a portion of a further alternative embodiment of a turbine housing assembly comprising a turbine housing according to the present invention;

FIG. 6 is a plot of normalised turbine efficiency at different pressure ratios between the first and second inlet volutes for various comparative examples of turbine inlet arrangements;

FIG. 7 is a cross-sectional schematic view of a further alternative embodiment of a turbine housing assembly comprising a nozzle ring according to the present invention; and

FIG. 8 is a cross-sectional schematic view of a further alternative embodiment of a turbine housing assembly comprising a turbine housing and a nozzle ring according to the present invention.

### DETAILED DESCRIPTION OF THE DRAWINGS

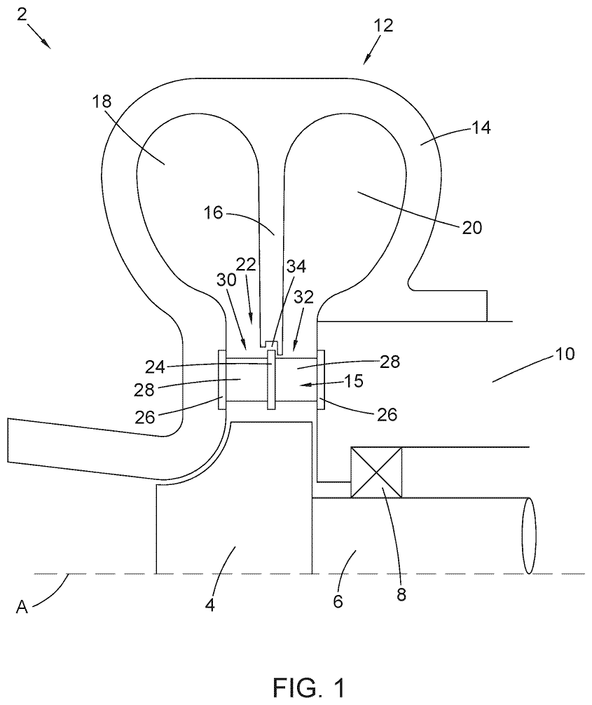

FIG. 1 shows a turbine 2 comprising a turbine wheel 4 mounted to a turbine shaft 6 supported by bearings 8 positioned within a bearing housing 10 and configured to rotate about a central axis A. The turbine 2 further comprises a turbine housing assembly 12 comprising a turbine housing 14 and a nozzle ring 15. The turbine housing 14 comprises a housing dividing wall 16 axially separating a first inlet volute 18 from a second inlet volute 20. The housing dividing wall 16 comprises a tip 22 circumferentially extending around the central axis A. The nozzle ring 15 comprises a nozzle ring dividing wall 24, a pair of end walls 26 and a plurality of nozzle vanes 28. The end walls 26 are received within corresponding recesses of the turbine housing 14 and the bearing housing 10. The end walls 26 are spaced generally equidistantly from the nozzle ring dividing wall 24 so as to define first and second nozzle passages 30, 32 therebetween. However, in alternative embodiments, the end walls 26 may be non-equidistance from the nozzle ring dividing wall 24, such that the first and second nozzle passages 30, 32 define different axial widths. Moreover, in further embodiments, nozzle ring 15 may not comprise the end walls 26. In such embodiments, the end walls 26 may form part of the turbine housing 14, the bearing housing, or another component. The nozzle vanes 28 extend axially parallel to the central axis A from the nozzle ring dividing wall 24 across the nozzle passages 30, 32 to a corresponding one of the end walls 26. The nozzle ring dividing wall 24 is axially aligned with the tip 22 of the housing dividing wall 16. A leakage passage 34 is defined between the tip 22 of the housing dividing wall and the outer part of the nozzle ring dividing wall 24

During use, exhaust gases received from separate cylinder banks of an internal combustion engine (not shown) are delivered to the first and second inlet volutes 18, 20. The exhaust gases pass from the inlet volutes 18, 20 through the nozzle passages 30, 32 to the turbine wheel 4, causing the turbine wheel 4 to rotate and produce mechanical power that is harnessed by the turbine shaft 6. Because the first and second inlet volutes 18, 20 are fed by different cylinder banks of the engine, the transient pressure profile of the exhaust gas in the first inlet volute 18 will be different to the transient pressure profile of the exhaust gas in the second inlet volute 20. Accordingly, across much of the operational cycle of the turbine 2, a pressure difference exists between the first and second inlet volutes 18, 20 which causes exhaust gas to pass between the first and second inlet volutes 18, 20 along the leakage passage 34. Flow between the first and second inlet volutes 18, 20 along the leakage passage 34 is referred to as “cross-talk”. Such cross-talk may act to reduce the pressure of the exhaust gas in the high pressure inlet volute and increase the pressure in the low pressure inlet volute by pressure pulse superposition, and may therefore reduce the amount of power produced by the turbine wheel 4.

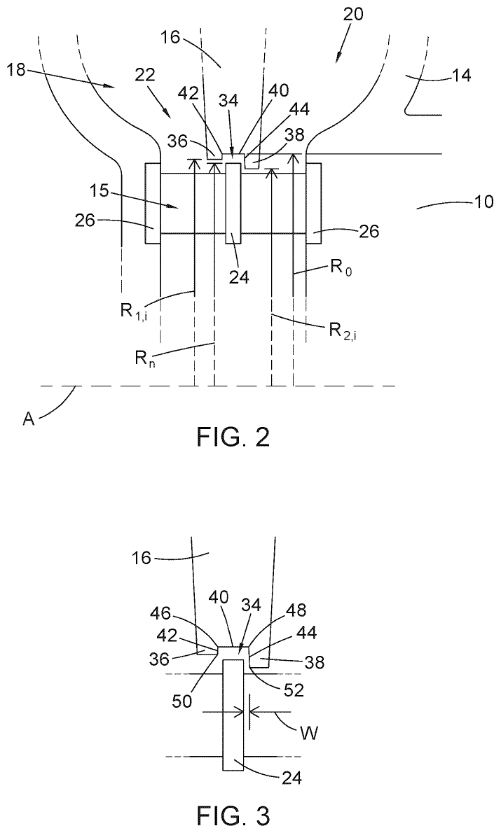

FIG. 2 shows a schematic enlarged sectional view of the leakage passage 34. As shown in the figure, the tip 22 of the housing dividing wall 16 is shaped such that it imparts a tortuous geometry upon the leakage passage 34. In particular, the tip 22 of the housing dividing wall 16 comprises a first formation 36 on the side of the first inlet volute 18 and a second formation 38 on the side of the second inlet volute 20. The first and second formation 36, 38 are radially extending circumferential flanges defining a circumferentially extending recess 40 therebetween. The first formation 36 comprises a first stepped portion 42 and the second formation comprises a second stepped portion 44. Both the first and second stepped portions 42, 44 extend radially inwards from the base of the recess 40. The nozzle ring dividing wall 24 is axially aligned with a midpoint between the first and second formations 36, 38.

The radially innermost point of the first formation 36 defines a first inner radius Rui relative to the axis A, the radially innermost point of the second formation 36 defines a second inner radius R_{2,i} relative to the axis A, and the radially outermost part of the recess 40 defines an outer radius Rₒ relative to the axis A. The first formation 36 may be considered to extend from the first inner radius R_{1,i} to the recess 40, and the second formation 38 may be considered to extend from the second inner radius R_{2,i} to the recess 40. Accordingly, the recess 40 may be considered to define an outer radius of the first formation 36 and an outer radius of the second formation 38. The radially outermost part of the nozzle ring dividing wall 24 defines a nozzle ring radius Rₙ.

It can be seen from the figure that the first inner radius R_{1,i} is larger than the nozzle ring radius Rₙ and the second inner radius R_{2,i} is smaller than the nozzle ring radius Rₙ. Accordingly, the leakage passage 34 comprises multiple bends causing any fluid passing therethrough to change direction several times, such a geometry being considered to be a tortuous one. This provides two key advantages. First, the length of the leakage passage 34 between the first inlet volute 18 and the second inlet volute 20 is increased compared to conventional arrangements in which the tip 22 defines a plain, axially straight, leakage passage 34 (i.e. a non-tortuous geometry in which the housing dividing wall 16 does not comprise the first and second formation 36, 38). Accordingly, the contact area between the surfaces defining the leakage passage 34 and the fluid passing therethrough is increased, and thus the fluid loses a larger amount of internal energy to frictional losses. Secondly, the leakage passage 34 comprises a number of bends which cause any fluid passing therethrough to change direction multiple times. Further frictional energy losses occur due to viscous effects when the fluid changes direction, and therefore these two factors in combination work together to ensure a larger amount of fluidic internal energy loss between the first and second inlet volutes 18, 20. Because the fluid passing through the leakage passage 34 loses a larger amount of energy, resistance to flow through the leakage passage 34 is increased and therefore the propensity for fluid to leak between the first and second inlet volutes 18, 20 is reduced.

As a result of the above configuration of the leakage passage 34, it will be appreciated that sealing between the first volute 18 and the second volute 20 is provided only via the means of fluidic friction within the exhaust gas passing through the leakage passage 34. Not only has this fluidic sealing been found to provide a sufficient mitigation against cross-talk so as to improve the efficiency of the turbine, this also negates the need to provide any form of mechanical sealing element such as an o-ring, seal-ring, interference fit or the like. Accordingly, the leakage passage 34 is substantially free of any mechanical sealing elements, thus reducing manufacture and assembly costs.

FIG. 3 shows a further enlarged view of the leakage passage 34. The first stepped portion 42 defines a circumferentially extending first inner edge 46 at the point at which it joins the base of the recess 40. Likewise, the second stepped portion 44 defines a circumferentially extending second inner edge 48 at the point at which it joins the base of the recess 40. The first and second inner circumferentially extending edges 46, 48 are generally arcuate in cross-section. Such an arcuate shape encourages any fluid passing through the leakage passage 34 to change between flowing in a radial or axial direction relative to the axis A to flowing in the other of the radial or axial direction relative to the axis A. By encouraging the fluid to change direction in this manner, this helps to ensure that internal energy is lost to viscous forces within the fluid. Substantially any suitable arcuate geometry may be used for this purpose, including for example radiussed (i.e. filleted) geometry, or a variable radius arcuate geometry.

The first stepped portion 42 defines a circumferentially extending first outer edge 50 at its radially innermost point and the second stepped portion 44 defines a circumferentially extending first outer edge 52 at its radially innermost point. In contrast to the first and second inner edges 46, 48, the first and second outer edges 50, 52 are sharp-edged. Because the outer edges 50, 52 are sharp, this encourages boundary layer separation over as the fluid passes over the outer edges 50, 52. Such boundary layer separation may have the effect of narrowing the available flow area of the leakage passage 34, thus increasing energy losses and resistance to flow therethrough, and thus further reducing the propensity of fluid to leak between the first and second inlet volutes 18, 20.

Returning to FIG. 2, it can be seen that the outer radius Rₒ of the recess 40 is larger than the nozzle ring radius Rₙ. This is necessary to provide a clearance (i.e. the leakage passage 34) between the nozzle ring dividing wall 24 and the housing dividing wall 16. If the clearance was not present, the nozzle ring dividing wall 24 and the housing dividing wall 16 would be in mechanical contact with one another. However, during use, the nozzle ring 15 and the turbine housing 14 would heat up and thermally expand at different rates, putting a large amount of stress on the nozzle ring dividing wall 24 and housing dividing wall 16 potentially resulting in mechanical failure (i.e. cracking or the like). In order to provide sufficient clearance between the nozzle ring dividing wall 24 and the housing dividing wall 16, the outer radius Rₒ is larger than the nozzle ring radius Rₙ by around 0.9%. However, in alternative embodiments, the outer radius Rₒ of the recess 40 may be between around 0.5% to around 1.5%, or around 1%, larger than the nozzle ring radius Rₙ.

With continued reference to FIG. 2, it can be seen that the first inner radius R_{1,i} is larger than the nozzle ring radius Rₙ. Because the first inner radius R_{1,i} is larger than the nozzle ring radius Rₙ this enables the nozzle ring dividing wall 24 to pass under the first formation 36 so that it may be aligned with the housing dividing wall 16. In particular, the first inner radius R_{1,i} is larger than the nozzle ring radius Rₙ by around 0.3%. However, it will be appreciated that in alternative embodiments the first inner radius R_{1,i} may be equal to the nozzle ring radius Rₙ or larger than the nozzle ring radius Rₙ by up to around 0.5%, in the range of around 0.1% to around 0.5% larger than the nozzle ring radius Rₙ, or around 0.2% larger than the nozzle ring radius Rₙ.

Moreover, whilst the second formation 38 is illustrated in FIG. 1 as being positioned on the same side of the housing dividing wall 16 as the bearing housing 10 and the first formation 36 is positioned on the opposite side of the housing dividing wall 16 to the bearing housing 10, it will be appreciated that in alternative embodiments the first formation 36 may be positioned on the same side of the housing dividing wall 16 as the bearing housing 10 and the second formation 38 may be positioned on the opposite side of the housing dividing wall 16 to the bearing housing 10. Such arrangements may aid assembly of the nozzle ring 15, which is generally received within the turbine housing 14 from same side as the bearing housing 10.

It can further be seen from FIG. 2 that the second inner radius R_{2,i} is smaller than the nozzle ring radius Rₙ. Because the second inner radius R_{2,i} is smaller than the nozzle ring radius Rₙ this creates a region of radial overlap between the nozzle dividing wall 24 and the stepped portion 44 of the second formation 38. Accordingly, this adds length to the leakage passage 34 and increases the tortuousness of the leakage passage 34, both of which contribute to increased energy loss through the leakage passage 34 and accordingly reduced flow therethrough. In particular, the second inner radius R_{2,i} is smaller than the nozzle ring radius Rₙ by around 1.1%. However, it will be appreciated that in alternative embodiments the second inner radius R_{2,i} may be around 0.3% to around 1.5%, and preferably around 0.4%, around 0.7% or around 1.1%, smaller than the nozzle ring radius Rₙ.

Returning to FIG. 3, it can be seen that the leakage passage 34 defines a width W in an axial direction between the side of the nozzle ring dividing wall 24 and the second formation 38. Preferably, the width W should have approximately the same dimension as the distance between the radially outermost part of the nozzle ring dividing wall 24 and the recess 40. That is to say, the width W should be approximately equal to the distance defined by the equation W=Rₒ−Rₙ. Preferably, the width W of the leakage passage 34 should be substantially constant across the length of the leakage passage 34 from the first volute 18 to the second volute 20. Accordingly, the axial distance between the first formation 36 and the nozzle ring dividing wall 24 is preferably also approximately equal to the width W above. Because the width W of the leakage passage 34 is substantially constant across the length of the leakage passage 34 from the first volute 18 to the second volute 20, this provides sufficient clearance between the housing dividing wall 16 and the nozzle ring dividing wall 24 to prevent mechanical contact therebetween. This avoids the formation of contact stresses which could lead to component failure. Nevertheless, it will be appreciated that in alternative embodiments the width W may have any suitable value, and may vary across the length of the leakage passage 34.

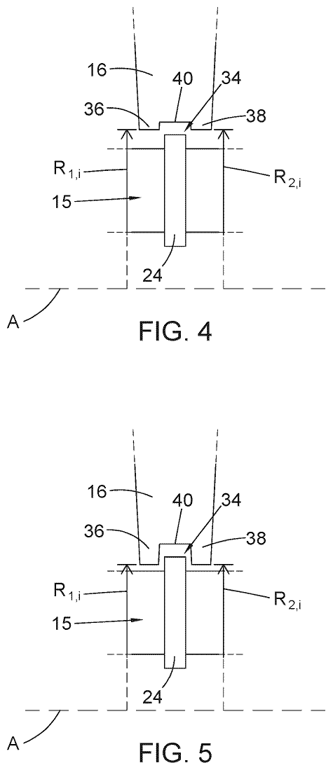

FIG. 4 shows a further embodiment of the invention in which the first formation 36 defines a first inner radius R_{1,i} that is aligned with (i.e. is the same size as) a second inner radius R_{2,i} defined by the second formation 38. In particular, the first inner radius R_{1,i} and the second inner radius R_{2,i} are around 0.3% larger than the nozzle ring radius Rₙ. However, in alternative embodiments the first inner radius R_{1,i} and the second inner radius R_{2,i} may be equal to the nozzle ring radius Rₙ or larger than the nozzle ring radius Rₙ by up to around 0.5%, in the range of around 0.1% to around 0.5% larger than the nozzle ring radius Rₙ, or around 0.2% larger than the nozzle ring radius Rₙ. In yet further alternative embodiments, the first inner radius R_{1,i} and the second inner radius R_{2,i} may define different radiuses relative to the axis A, in which both the first inner radius R_{1,i} and the second inner radius R_{2,i} are equal to or larger than the nozzle ring radius Rₙ.

FIG. 5 shows yet another embodiment of the invention in which the first formation 36 defines a first inner radius R_{1,i} that is aligned with (i.e. is the same size as) a second inner radius R_{2,i} defined by the second formation 38. However, in the embodiment of FIG. 5 both the first inner radius R_{1,i} and the second inner radius Raj are smaller than the nozzle ring radius Rₙ. In particular, the first inner radius R_{1,i} and the second inner radius R_{2,i} are smaller than the nozzle ring radius Rₙ by around 1.1%. However, it will be appreciated that in alternative embodiments the first inner radius R_{1,i} and the second inner radius R_{2,i} may be around 0.3% to around 1.5%, and preferably around 0.4%, around 0.7% or around 1.1%, smaller than the nozzle ring radius Rₙ. In yet further alternative embodiments, the first inner radius R_{1,i} and the second inner radius R_{2,i} may define different radiuses relative to the axis A, in which both the first inner radius R_{1,i} and the second inner radius Raj are smaller than the nozzle ring radius Rₙ.

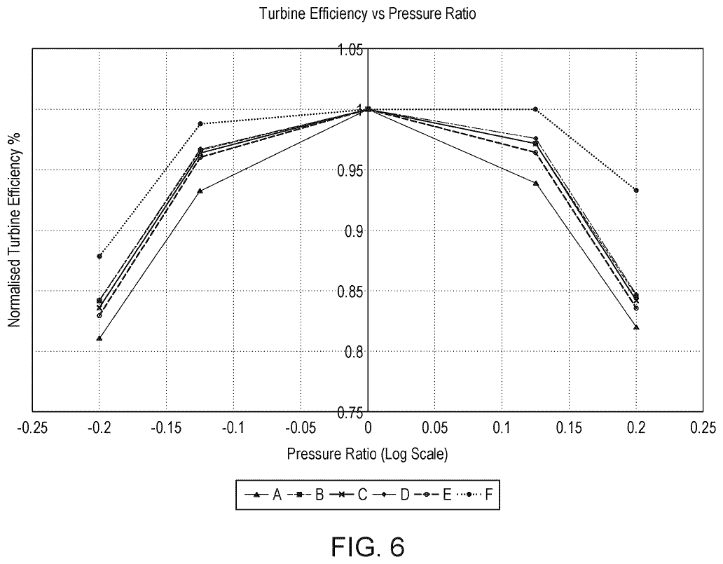

FIG. 6 shows a plot of normalised turbine efficiency at different pressure ratios between the first and second inlet volutes 18, 20 for various comparative examples A to F of turbine inlet arrangements. The data depicted in FIG. 6 has been arrived at analytically, using computational fluid dynamics modelling. The dimensions of the example turbine inlet arrangements A to F compared in FIG. 6 are shown below in Table 1. In particular, Table 1 shows the relative size difference in percentage terms between the first inner radius R_{1,i}, the second inner radius R_{2,i}, and the outer radius Rₒ compared to the nozzle ring radius Rₙ. That is to say, Table 1 shows how much bigger or smaller the first inner radius R_{1,i}, the second inner radius R_{2,1}, and the outer radius Rₒ are compared to the nozzle ring radius Rₙ as a proportion of the nozzle ring radius Rₙ.

TABLE 1
Dimension % difference from Rₙ

| Dim. | A | B | C | D | E | F |
|---|---|---|---|---|---|---|
| R_{1, I} | 0.91 | 0.36 | 0.36 | 0.36 | 0.36 | 0 |
| R_{2, I} | 0.91 | 0.18 | −0.36 | −0.73 | −1.14 | 0 |
| Rₒ | 0.91 | 0.91 | 0.91 | 0.91 | 0.91 | 0 |

Example A is a comparative example of a conventional arrangement in which the first inner radius R_{1,i}, the second inner radius R_{2,i} and the outer radius Rₒ are all equal. As such, this corresponds to an arrangement in which the tip 22 of the housing dividing wall 16 is completely flat such that the leakage passage 34 is entirely axially straight (and does not comprise bends or the like). Example B corresponds to the arrangement of FIG. 4 discussed above. Examples C to E correspond to the arrangement of FIGS. 2 and 3 discussed above, with increasing amounts of radial overlap between the second formation 38 and the nozzle dividing wall 24. Example F corresponds to a theoretical “perfect” arrangement in which the leakage passage 34 is completely eliminated. Accordingly, whilst Examples A and F do not comprise tortuous geometry, all of Examples B to E do comprise tortuous geometry.

It can be seen from FIG. 6, the that the most efficient arrangement of the above examples across all pressure ratios is the theoretical “perfect” arrangement of example F. Likewise, the worst performing arrangement is Example A, which corresponds to a conventional arrangement having a straight (i.e. flat, non-tortuous) leakage passage 34. However, all of the examples comprising tortuous geometry, namely Examples B to E, offer improved performance over the conventional arrangement of Example A. Unsurprisingly, these examples are unable to meet the performance offered by the theoretical “perfect” arrangement of Example F. Accordingly, It can be ascertained that the use of a leakage passage 34 having a tortuous geometry offers improved turbine efficiency. It is believed that this improved turbine efficiency is due to the tortuous nature of the leakage passage 34 acting to reduce fluid flow through the leakage passage 34 and thereby reducing the propensity for cross-talk to occur between the first and second inlet volutes 18, 20.

It can further be ascertained from FIG. 6 that the performance of each example sealing arrangement increases with an increasing amount of radial overlap between the second formation 38 and the nozzle ring dividing wall 24. In particular, it is notable that of the four examples comprising tortuous geometry, Example B (which does not comprise any radial overlap between the second formation 38 and the nozzle ring 24) exhibits the least improvement over the conventional arrangement of Example A, whilst Example E (which comprises the most radial overlap between the second formation 38 and the nozzle ring 24) exhibits the best performance improvement over the conventional arrangement of Example A. Nevertheless, the variation in performance between Example B and Example E is small in comparison to the improvement both arrangements offer over the conventional arrangement of Example A.

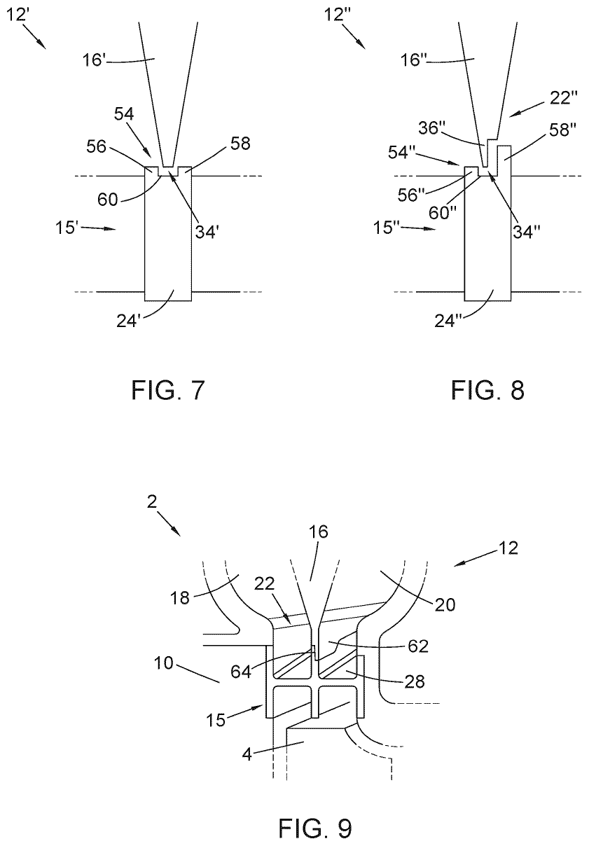

Although the invention above has been described in relation to tortuous geometry that is imparted upon the leakage passage 34 by the tip 22 of the housing dividing wall 16, it will be appreciated that in further embodiments the nozzle ring dividing wall 24 may be configured to impart the tortuous geometry as an alternative to, or in combination with, the tip 22 of the housing dividing wall 16. Such an embodiment is shown in FIG. 7 which depicts a turbine housing assembly 12′ comprising a nozzle ring 15′ and a housing dividing wall 16′ which define a leakage passage 34′ therebetween. The nozzle ring 15′ comprises a nozzle ring dividing wall 24′ having a circumferentially extending tip 54. The tip 54 of the nozzle ring 24′ comprises a first formation 56 and a second formation 58 which define a recess 60 therebetween. Accordingly, the tip 54 of the nozzle ring 24′ is configured to impart a tortuous geometry onto the leakage passage 34′ in a corresponding manner to the tip 22 of the housing dividing wall 16 discussed above in relation to the previous embodiments. Accordingly, the nozzle ring 24′ of the present embodiment is configured to offer improved leakage performance in a substantially identical manner to the embodiments discussed above (in particular, it is the corollary to Example B above). For completeness, it will further be appreciated that that the formations 56, 58 of the nozzle ring dividing wall 24′ may have corresponding axial overlaps with the housing dividing wall 16′. In particular, one or both of the formations 56, 58 may radially overlap with the housing dividing wall 16′.

FIG. 8 shows yet another embodiment of a turbine housing assembly 12″ according to the present invention. The turbine housing assembly 12″ comprises a nozzle ring 15″ and a housing dividing wall 16″ which define a leakage passage 34″ therebetween. The housing dividing wall 16″ comprises a circumferentially extending tip 22″ comprising a formation 36″. The nozzle ring 15″ comprises a nozzle ring dividing wall 24″ having a circumferentially extending tip 54″. The tip 54″ of the nozzle ring 24″ comprises a first formation 56″ and a second formation 58″ which define a recess 60″ therebetween. The nozzle ring dividing wall 24″ and the housing dividing wall 16″ are aligned such that the formation 36″ of the housing dividing wall 16″ is aligned with the midpoint of the recess 60″ of the tip 54″ of the nozzle ring dividing wall 24″. Accordingly, the formations 56″, 58″ of the tip 54″ of the nozzle ring dividing wall 24″ and the formation 36″ of the tip 22″ of the housing dividing wall 16″ are collectively configured to impart a tortuous geometry onto the leakage passage 34″. Accordingly, the nozzle ring 24″ of the embodiment of FIG. 8 offers improved leakage performance in a substantially identical manner to the embodiments discussed above.

FIG. 9 shows a cross-sectional view of a further embodiment of a turbine 2 according to the present invention. The embodiment of FIG. 9 is substantially the same as the previously described embodiments, aside from the addition of radially extending tabs 62 formed by the tip 22 of the housing dividing wall 16. The radially extending tabs 62 are received within correspondingly shaped sockets 64 formed by the nozzle ring dividing wall 24. The receipt of the tabs 62 within the sockets 64 prevents rotation of the nozzle ring 15 relative to the turbine axis A, thereby ensuring that the nozzle ring 15 remains in a particular rotational orientation and does not move during use (e.g. due to the force of exhaust gas on the nozzle vanes 28).

In the illustrated embodiment, the tabs 62 are around half the thickness of the tip 22 of the turbine hosing dividing wall 16. Likewise, the sockets 64 are around half the thickness of the nozzle ring dividing wall 24. The tabs 62 and sockets 64 are relatively small by angular extent about the turbine axis, and in particular may define only a small portion of the circumference of the tip 22 of the housing dividing wall 16 and the outer circumference of the nozzle ring dividing wall 24. Preferably each of the tabs 62 and sockets 64 have an extent in the circumferential direction relative to the turbine axis A that is no more than around 10% of the circumference of the tip 22 and/or nozzle ring dividing wall 24, and in particular no more than around 5%.

Any number of tabs 62 and corresponding sockets 64 may be provided. In principle, the anti-rotational advantages provided by the tabs 62 and sockets 64 can be achieved with the presence of only a single tab 62 and corresponding socket 64. However, preferably at least three sets of tabs 62 and corresponding sockets 64 may be provided. When multiple tabs 62 and corresponding sockets 64 are provided, these may be equispaced about the turbine axis A. It will be appreciated that it may be beneficial to position tab 62 and corresponding socket 64 so that it is not equispaced (i.e. introducing a degree of rotational asymmetry). This ensures that the nozzle ring 15 may only be assembled to the turbine housing 14 is a single angular position.

It will be appreciated that outside of the circumferential extent of the tabs 62 and sockets 64, the geometries of the tip 22 of the housing dividing wall 16 and the nozzle ring dividing wall 24 may be otherwise unaffected and unchanged from the various embodiments described above. Moreover, in further embodiments, the tab 62 may be formed, for example, as a radially extending portion of either the first formation 36 or the second formation 38. In such embodiments, the nozzle ring dividing wall 24 may be sized so that it is as wide as the housing dividing wall 16, so that a corresponding socket 64 may be formed in the nozzle ring dividing wall 24 to receive the tab 62.

Although the embodiment of FIG. 9 has been described with the tabs 62 formed by the housing dividing wall 16 and the sockets 64 formed by the nozzle ring dividing wall 24, it will be appreciated that in other embodiments the opposite arrangement may be possible, e.g. with the tabs 62 formed by the nozzle ring dividing wall 24 and the sockets 64 formed by the housing dividing wall 16. In yet further embodiments, each of the housing dividing wall 16 and the nozzle ring dividing wall 24 may define a mixture of tabs 62 and sockets 64.

With regard to all of the embodiments discussed above, whilst the formations described are in the form of radially extending flanges of the housing dividing wall 16 or the nozzle ring dividing wall 24, it will be appreciated that substantially any mechanical structure may be used to impart a tortuous geometry upon the leakage passage 34. Such formations may comprise, inter alia, edges, protrusions, recesses, labyrinth seals, steps, or the like. Such formations may be integrally formed with the housing dividing wall 16 or nozzle ring dividing wall 24, or may be provided as separate components.

Whilst the above embodiments contemplate the use of a pair of formations to define a tortuous geometry, it will be appreciated that the principles of the invention will work equally well where only a single formation is used, provided such a formation is able to impart a tortuous geometry upon the leakage passage 34.

Whilst the nozzle ring 15 described above has been illustrated as a single integral component, it will be appreciated that in practice the nozzle ring 15 may be composed of a number of separate components assembled together to define a divided nozzle ring.

1. A turbine housing comprising:
a housing dividing wall circumferentially extending around a central axis of the turbine housing, the housing dividing wall axially separating a first inlet volute and a second inlet volute;
wherein the housing dividing wall comprises a circumferentially extending tip configured to receive a nozzle ring, the tip being shaped to impart a tortuous geometry upon a leakage passage defined between the first inlet volute and the second inlet volute.

2. The turbine housing according to claim 1, wherein the tip comprises at least one of: a formation configured to impart a tortuous geometry upon the leakage passage and a tab extending in a radial direction towards the central axis.

3. The turbine housing according to claim 1, wherein the formation comprises a stepped portion circumferentially extending around the central axis, the stepped portion defining at least part of the leakage passage, and wherein either:
the stepped portion defines an inner edge, and wherein the inner edge is arcuate or
the stepped portion defines an outer edge, and wherein the outer edge is sharp.

4. (canceled)

5. (canceled)

6. The turbine housing according to claim 2, wherein:
the formation is a first formation; and
the tip further comprises a second formation defining at least part of the leakage passage, the second formation being configured to impart a tortuous geometry upon the leakage passage in combination with the first formation,
wherein the second formation is a second stepped portion circumferentially extending around the central axis, the stepped portion defining at least part of the leakage passage, and
wherein either:
the second stepped portion defines an inner edge, and wherein the inner edge is arcuate and
the second stepped portion defines an outer edge, and wherein the outer edge is sharp.

7. (canceled)

8. (canceled)

9. (canceled)

10. The turbine housing according to claim 6, wherein the second formation is positioned opposite to the first formation about a plane normal to the central axis so as to define a recess therebetween.

11. (canceled)

12. The turbine housing assembly comprising:
the turbine housing of claim 1; and
a nozzle ring comprising a nozzle ring dividing wall and at least one nozzle vane extending from the nozzle ring dividing wall;
wherein the nozzle ring dividing wall is aligned with the tip of the housing dividing wall such that the nozzle ring dividing wall and the tip of the housing dividing wall define the leakage passage therebetween.

13. The turbine housing assembly according to claim 12, wherein:
the formation defines an outer radius (Rₒ) and an inner radius (Rᵢ);
the nozzle ring dividing wall defines a nozzle ring radius (Rₙ); and
the outer radius (Rₒ) is larger than the nozzle ring radius (Rₙ).

14. The turbine housing assembly according to claim 13, wherein at least one of:
the outer radius (Rₒ) of the formation is around 0.5% to around 1.5%, and preferably around 0.9% or around 1%, larger than the nozzle ring radius (Rₙ) and
the inner radius (Rᵢ) is equal to or greater than the nozzle ring radius (Rₙ), the inner radius (Rᵢ) is further around 0.1% to around 0.5%, and preferably around 0.2% or 0.3%, larger than the nozzle ring radius (Rₙ).

15. (canceled)

16. (canceled)

17. The turbine housing assembly according to claim 15, wherein:
the turbine comprises:
a housing dividing wall circumferentially extending around a central axis of the turbine housing, the housing dividing wall axially separating a first inlet volute and a second inlet volute;
wherein the housing dividing wall comprises a circumferentially extending tip configured to receive a nozzle ring, the tip being shaped to impart a tortuous geometry upon a leakage passage defined between the first inlet volute and the second inlet volute
turbine housing according to any of claims 2 to 5,
a housing dividing wall circumferentially extending around a central axis of the turbine housing, the housing dividing wall axially separating a first inlet volute and a second inlet volute;
wherein the housing dividing wall comprises a circumferentially extending tip configured to receive a nozzle ring, the tip being shaped to impart a tortuous geometry upon a leakage passage defined between the first inlet volute and the second inlet volute,
wherein the tip comprises a formation configured to impart a tortuous geometry upon the leakage passage,
wherein:
the formation is a first formation; and
the tip further comprises a second formation defining at least part of the leakage passage, the second formation being configured to impart a tortuous geometry upon the leakage passage in combination with the first formation;
the inner radius (Rᵢ) is an inner radius of the first formation and defines a first inner radius (R_{1,i});
the second formation defines a second inner radius (R_{2,i});
the outer radius (Rₒ) is a common outer radius of the first and second formations;
the first inner radius (R_{1,i}) and the second inner radius (R_{2,i}) are equal to or larger than the nozzle ring radius (Rₙ), wherein the first inner radius (R_{1,i}) and the second inner radius (R_{2,i}) are around 0.1% to around 0.5%, and preferably around 0.2% or 0.18%, larger than the nozzle ring radius (Rₙ).

18. (canceled)

19. The turbine housing assembly according to claim 13, wherein:
the inner radius (Rᵢ) is smaller than the nozzle ring radius (Rₙ) and
the inner radius (Rᵢ) of the formation is around 0.3% to around 1.5%, and preferably around 0.4%, around 0.7% or around 1.1%, smaller than the nozzle ring radius (Rₙ)F.

20. (canceled)

21. The turbine housing assembly according to claim 19, wherein:
the turbine comprises:
a housing dividing wall circumferentially extending around a central axis of the turbine housing, the housing dividing wall axially separating a first inlet volute and a second inlet volute;
wherein the housing dividing wall comprises a circumferentially extending tip configured to receive a nozzle ring, the tip being shaped to impart a tortuous geometry upon a leakage passage defined between the first inlet volute and the second inlet volute
turbine housing according to any of claims 2 to 5,
a housing dividing wall circumferentially extending around a central axis of the turbine housing, the housing dividing wall axially separating a first inlet volute and a second inlet volute;
wherein the housing dividing wall comprises a circumferentially extending tip configured to receive a nozzle ring, the tip being shaped to impart a tortuous geometry upon a leakage passage defined between the first inlet volute and the second inlet volute,
wherein the tip comprises a formation configured to impart a tortuous geometry upon the leakage passage,
wherein:
the formation is a first formation; and
the tip further comprises a second formation defining at least part of the leakage passage, the second formation being configured to impart a tortuous geometry upon the leakage passage in combination with the first formation;
the first formation defines a first inner radius (R_{1,i});
the inner radius (Rᵢ) is an inner radius of the second formation and defines a second inner radius (R_{2,i});
the outer radius (Rₒ) is a common outer radius of the first and second formations;
the first inner radius (R_{1,i}) is equal to or greater than the nozzle ring radius (Rₙ); and
the second inner radius (R_{2,i}) is less than the nozzle ring radius (Rₙ),
wherein at least one of: the first inner radius (R_{1,i}) is around 0.1% to around 0.5%, and preferably around 0.2% or 0.18%, larger than the nozzle ring radius (Rₙ); and
wherein the second inner radius (R_{2,i}) is around 0.3% to around 1.5%, and preferably around 0.4%, around 0.7% or around 1.1%, smaller than the nozzle ring radius (Rₙ).

22. (canceled)

23. (canceled)

24. The turbine housing assembly according to claim 13, wherein:
the turbine comprises:
a housing dividing wall circumferentially extending around a central axis of the turbine housing, the housing dividing wall axially separating a first inlet volute and a second inlet volute;
wherein the housing dividing wall comprises a circumferentially extending tip configured to receive a nozzle ring, the tip being shaped to impart a tortuous geometry upon a leakage passage defined between the first inlet volute and the second inlet volute turbine housing according to any of claims 2 to 5,
a housing dividing wall circumferentially extending around a central axis of the turbine housing, the housing dividing wall axially separating a first inlet volute and a second inlet volute;
wherein the housing dividing wall comprises a circumferentially extending tip configured to receive a nozzle ring, the tip being shaped to impart a tortuous geometry upon a leakage passage defined between the first inlet volute and the second inlet volute,
wherein the tip comprises a formation configured to impart a tortuous geometry upon the leakage passage,
wherein:
the formation is a first formation; and
the tip further comprises a second formation defining at least part of the leakage passage, the second formation being configured to impart a tortuous geometry upon the leakage passage in combination with the first formation;
the inner radius (Rᵢ) is an inner radius of the first formation and defines a first inner radius (R_{1,i});
the second formation defines a second inner radius (R_{2,i});
the outer radius (Rₒ) is a common outer radius of the first and second formations;
the first inner radius (R_{1,i}) is equal to or less than the nozzle ring radius (Rₙ); and
the second inner radius (R_{2,i}) is equal to or less than the nozzle ring radius (Rₙ),
wherein the first inner radius (R_{1,i}) and the second inner radius (R_{2,i}) are around 0.3% to around 1.5%, and preferably around 0.4%, around 0.7% or around 1.1%, smaller than the nozzle ring radius (Rₙ).

25. (canceled)

26. The turbine housing assembly according to claim 12, wherein:
the turbine comprises
a housing dividing wall circumferentially extending around a central axis of the turbine housing, the housing dividing wall axially separating a first inlet volute and a second inlet volute;
wherein the housing dividing wall comprises a circumferentially extending tip configured to receive a nozzle ring, the tip being shaped to impart a tortuous geometry upon a leakage passage defined between the first inlet volute and the second inlet volute turbine housing according to any of claims 2 to 5,
a housing dividing wall circumferentially extending around a central axis of the turbine housing, the housing dividing wall axially separating a first inlet volute and a second inlet volute;
wherein the housing dividing wall comprises a circumferentially extending tip configured to receive a nozzle ring, the tip being shaped to impart a tortuous geometry upon a leakage passage defined between the first inlet volute and the second inlet volute,
wherein the tip comprises a formation configured to impart a tortuous geometry upon the leakage passage,
wherein:
the formation is a first formation; and
the tip further comprises a second formation defining at least part of the leakage passage, the second formation being configured to impart a tortuous geometry upon the leakage passage in combination with the first formation; and
wherein the nozzle ring dividing wall is axially aligned with a midpoint between the first formation and the second formation.

27. A nozzle ring for a twin-entry turbine comprising a first inlet volute and a second inlet volute separated by a housing dividing wall, the nozzle ring comprising:
a nozzle ring dividing wall circumferentially extending around a central axis of the nozzle ring;
at least one nozzle vane extending from the nozzle ring dividing wall;
wherein the nozzle ring dividing wall comprises a circumferentially extending tip configured to be received by the housing dividing wall, the tip being shaped to impart a tortuous geometry upon a leakage passage defined between the first inlet volute and the second inlet volute.

28. The nozzle ring according to claim 27, wherein the tip comprises a formation configured to impart a tortuous geometry upon the leakage passage,
wherein the formation comprises a stepped portion circumferentially extending around the central axis, the stepped portion defining at least part of the leakage passage, and
wherein either:
the stepped portion defines an outer edge, and wherein the outer edge is sharp or the stepped portion defines an outer edge, and wherein the outer edge is sharp.

29. (canceled)

30. (canceled)

31. (canceled)

32. The nozzle ring according to claim 27, wherein:
the formation is a first formation; and
the tip further comprises a second formation defining at least part of the leakage passage, the second formation being configured to impart a tortuous geometry upon the leakage passage in combination with the first formation.

33. A nozzle ring according to claim 32, wherein the second formation is a second stepped portion circumferentially extending around the central axis, the stepped portion defining at least part of the leakage passage,
wherein either:
the second stepped portion defines an inner edge, and wherein the inner edge is arcuate or
the second stepped portion defines an outer edge, and wherein the outer edge is sharp.

34. (canceled)

35. (canceled)

36. The nozzle ring according to claim 32, wherein the second formation is positioned opposite to the first formation about a plane normal to the central axis so as to define a recess therebetween.

37. (canceled)

38. The turbine housing assembly comprising:
the nozzle ring of claim 27; and
a turbine housing comprising a housing dividing wall circumferentially extending around a central axis of the turbine housing, the housing dividing wall axially separating a turbine inlet into a first inlet volute and a second inlet volute, wherein the housing dividing wall comprises a circumferentially extending tip;
wherein either:
the tip of the nozzle ring dividing wall is aligned with the tip of the housing dividing wall such that the tip of the nozzle ring dividing wall and the tip of the housing dividing wall define the leakage passage therebetween or
the nozzle ring dividing wall comprises a socket configured to receive a corresponding tab of the housing dividing wall.

39. The turbine housing assembly comprising:
the turbine housing of claim 1; and
a nozzle ring comprising
a first inlet volute and a second inlet volute separated by a housing dividing wall,
the nozzle ring comprising:
a nozzle ring dividing wall circumferentially extending around a central axis of the nozzle ring;
at least one nozzle vane extending from the nozzle ring dividing wall;
wherein the nozzle ring dividing wall comprises a circumferentially extending tip configured to be received by the housing dividing wall, the tip being shaped to impart a tortuous geometry upon a leakage passage defined between the first inlet volute and the second inlet volute;
wherein the tip of the nozzle ring dividing wall is aligned with the tip of the housing dividing wall such that the tip of the nozzle ring dividing wall and the tip of the housing dividing wall define the leakage passage therebetween.
